(19) United States
(12) Patent Application Publication
(10) Pub. No.: US 2020/0239062 A1
(43) Pub. Date: Jul. 30, 2020

(54) RACK AND PINION STEERING APPARATUS

(71) Applicant: HYUNDAI MOBIS Co., Ltd., Seoul (KR)

(72) Inventor: Hee Su CHO, Yongin-si (KR)

(21) Appl. No.: 16/747,385

(22) Filed: Jan. 20, 2020

(30) Foreign Application Priority Data
Jan. 30, 2019 (KR) 10-2019-0011753

(51) Int. Cl. B62D 3/12

(52) U.S. Cl. CPC B62D 3/12

(57) ABSTRACT

A rack and pinion steering apparatus including: a housing; a pinion inserted into the housing and configured to be rotatable; a rack configured to pass through the housing and engage with the pinion so that the rack moves linearly; a support mounted to the housing; and a liner supported by the support, coming into contact with the rack, and having space that stores the lubricant. In the rack and pinion steering apparatus, abrasion of the components may be reduced, and vibration and noise may be mitigated.

### CROSS-REFERENCE TO RELATED APPLICATION

This application claims priority from and the benefit of Korean Patent Application No. 10-2019-0011753, filed on Jan. 30, 2019, which is hereby incorporated by reference for all purposes as if set forth herein.

### BACKGROUND

### Field

Exemplary embodiments relate to a rack and pinion steering apparatus, and more particularly, to a rack and pinion steering apparatus capable of restraining abrasion of components and mitigating vibration and noise.

### Discussion of the Background

Generally, a steering apparatus for a vehicle includes all devices which are used to arbitrarily change a travel direction of the vehicle depending on the intention of a driver of the vehicle. For example, if a steering wheel rotates, the rotational motion thereof is transmitted to steering gears. Thereby, wheels of the vehicle are changed in angle, so that the travel direction of the vehicle may be changed.

A gear box of a steering apparatus using a rack and a pinion receives rotational motion from a steering shaft. The gear box includes a pinion shaft which is provided with a pinion gear on an outer circumferential surface thereof, and a rack bar which has a rack gear engaging with the pinion gear to translate the rotational motion input from the steering shaft into linear motion.

The gearbox of the steering apparatus using the rack and the pinion includes a housing, a bearing, a coupling ring, a top plug, and a dust seal. The housing houses a pinion shaft. The bearing is installed in the housing to enclose a portion of an outer circumferential surface of the pinion shaft and rotatably support the pinion shaft. The coupling ring has one side seated on the outer circumferential surface of the pinion shaft and the other side seated on a top surface of the bearing, and is compressed between the pinion shaft and the bearing so that the bearing can be supported by the coupling ring. The top plug is coupled to an inner circumferential surface of an upper portion of the housing and installed on an upper portion of the bearing. The pinion shaft passes through the top plug. The dust seal is inserted onto an inner circumferential surface of an upper portion of the top plug to enclose a portion of the outer circumferential surface of the pinion shaft.

In the steering apparatus using the rack and the pinion according to the conventional art having the above-mentioned configuration, a rack support has elasticity and supports the rack so that engagement between the rack and the pinion shaft can be maintained.

However, if lateral and axial loads are continuously applied to the rack support, a gap occurs due to abrasion of the rack support that supports the rack. Thus, noise may occur because of the gap. Therefore, there is a need to improve this configuration.

The related art of the present disclosure is disclosed in Korean Patent Application Laid-Open No. 2008-0058649 (published on Jun. 26, 2008, entitled “RACK-PINION TYPE STEERING APPARATUS”).

The above information disclosed in this Background section is only for enhancement of understanding of the background of the invention and, therefore, it may contain information that does not constitute prior art.

### SUMMARY

Exemplary embodiments of the present invention are directed to a rack and pinion steering apparatus capable of restraining abrasion of components and mitigating vibration and noise.

In an exemplary embodiment, a rack and pinion steering apparatus includes: a housing; a pinion inserted into the housing and configured to be rotatable; a rack configured to pass through the housing and engage with the pinion so that the rack moves linearly; a support mounted to the housing; and a liner supported by the support, coming into contact with the rack and configured to store a lubricant therein.

The support may include: a support insert part inserted into a mounting hole formed in the housing, and configured to support the liner; and a support fixing part coupled to the housing and configured to cover the mounting hole.

The support may include an elastic support part disposed between the support insert part and the support fixing part and configured to elastically support the support insert part.

The support insert part may have a shape corresponding to a shape of the liner and come into surface contact with the liner.

The liner may include: a liner insert part inserted into the support; and a liner contact part extending from the liner insert part, coming into contact with the rack, and having space that stores the lubricant.

The liner insert part may be inserted into an insert depression formed in the support so that the liner is prevented from moving.

A plurality of recesses may be formed in the liner contact part so that the lubricant is stored in the plurality of recesses.

The recesses may be formed in the liner contact part of the liner through a pressing process.

The liner may further include a liner coating layer applied to the liner contact part and configured to enhance durability of the liner.

The liner coating layer may be formed by a diamond-like carbon (DLC) coating method.

In a rack and pinion steering apparatus in accordance with an embodiment of the present disclosure, a lubricant is stored in a liner that comes into contact with a rack, so that the use time of the lubricant can be increased.

In the rack and pinion steering apparatus in accordance with an embodiment of the present disclosure, recesses that can store the lubricant are formed in a liner contact part, whereby the contact surface area between the liner and the rack can be reduced, and abrasion between the liner and the rack can be restrained.

In the rack and pinion steering apparatus in accordance with an embodiment of the present disclosure, the liner contact part is coated with a liner coating layer, so that the durability and the abrasion resistance of the liner contact part can be enhanced, whereby the lifetime of the liner can be increased.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram schematically illustrating a rack and pinion steering apparatus in accordance with an embodiment of the present disclosure.

FIG. 2 is a diagram schematically illustrating a support in accordance with an embodiment of the present disclosure.

FIG. 3 is a perspective view schematically illustrating a liner in accordance with an embodiment of the present disclosure.

FIG. 4 is a sectional view schematically illustrating the liner in accordance with an embodiment of the present disclosure.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

Hereinafter, a rack and pinion steering apparatus will be described below with reference to the accompanying drawings through various examples of embodiments. It should be noted that the drawings are not to precise scale and may be exaggerated in thickness of lines or sizes of components for descriptive convenience and clarity only. Unless defined otherwise, it is to be understood that all the terms (including technical and scientific terms) used in the specification have the same meaning as those that are understood by those who skilled in the art. Further, the terms defined by the dictionary generally used should not be ideally or excessively formally defined unless clearly defined specifically. The terms and words used for elements in the description of the present disclosure are defined based on the functions of the elements in the present disclosure. The terms and words may be changed depending on the intention or custom of users or operators, so that they must be defined based on the whole content of the present specification.

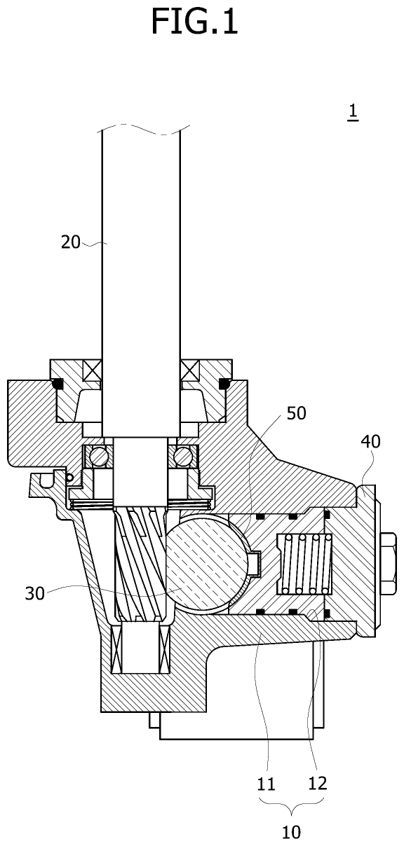

FIG. 1 is a diagram schematically illustrating a rack and pinion steering apparatus 1 in accordance with an exemplary embodiment of the present disclosure. Referring to FIG. 1, the rack and pinion steering apparatus 1 in accordance with an exemplary embodiment of the present disclosure includes a housing 10, a pinion 20, a rack 30, a support 40, and a liner 50.

The housing 10 is mounted to a vehicle body. A rack gear and a pinion gear engage with each other in the housing 10. For example, the housing 10 may function as a gear box.

The pinion 20 is inserted into the housing 10 and provided so as to be rotatable. The pinion 20 receives rotational motion from a steering shaft (not illustrated).

The rack 30 passes through the housing 10 and engages with the pinion 20 so that the rack 30 can move linearly. For example, the pinion gear of the pinion 20 and the rack gear of the rack 30 engage with each other. Rotational motion of the pinion 20 may be translated into linear motion by the rack 30. When the rack 30 linearly moves, the vehicle may be steered.

The support 40 is mounted to the housing 10. The liner 50 supported by the support 40 comes into contact with the rack 30. Thereby, the rack 30 is guided to remain close contact with the pinion 20. Here, space for storing a lubricant is formed in the liner 50. For example, grease may be used as the lubricant.

The housing 10 may include a housing body 11 into which the pinion 20 is inserted and through which the rack 30 passes, and a mounting hole 12 formed in the housing body 11 so that the support 40 is inserted into the housing body 11 through the mounting hole 12.

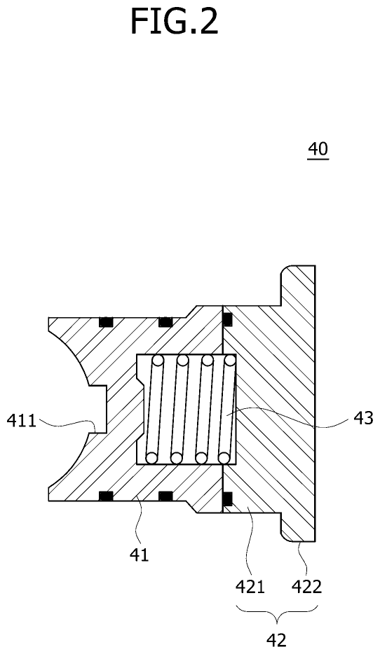

FIG. 2 is a diagram schematically illustrating the support 40 in accordance with an embodiment of the present disclosure. Referring to FIG. 2, the support 40 in accordance with an embodiment of the present disclosure includes a support insert part 41, a support fixing part 42, and an elastic support part 43.

The support insert part 41 is inserted into the housing 10 and supports the liner 50. For example, the support insert part 41 is inserted into the mounting hole 12 and is able to support the liner 50 that comes into contact with the rack 30. Here, the support insert part 41 may have a shape corresponding to that of the liner 50 to come into surface contact with the liner 50.

The support fixing part 42 is coupled to the housing 10 and covers the mounting hole 12. For example, the support fixing part 42 may include a fixing insert part 421 which is inserted into the mounting hole 12, and a fixing coupling part 422 which is formed on the fixing insert part 421 and coupled to the housing 10 from the outside of the housing 10.

The elastic support part 43 is disposed between the support insert part 41 and the support fixing part 42 and elastically supports the support insert part 41. For example, the elastic support part 43 may have a coil spring shape and support the support fixing part 42.

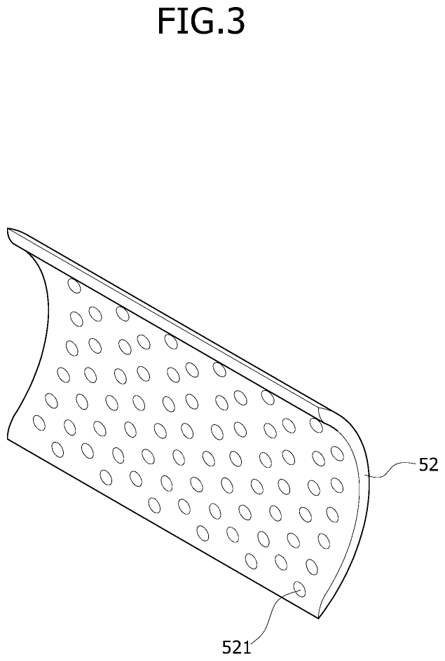

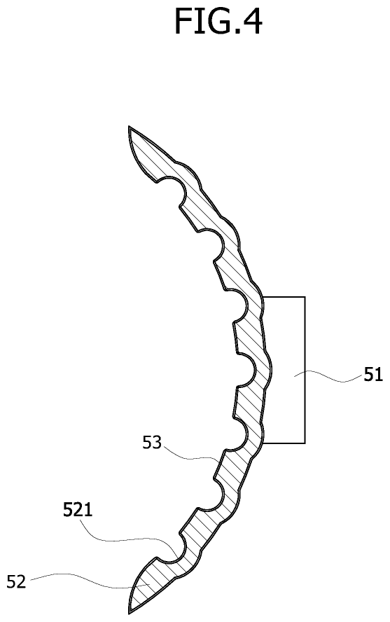

FIG. 3 is a perspective view schematically illustrating the liner 50 in accordance with an embodiment of the present disclosure, and FIG. 4 is a sectional view schematically illustrating the liner 50 in accordance with the embodiment of the present disclosure. Referring to FIGS. 3 and 4, the liner 50 in accordance with an embodiment of the present disclosure includes a liner insert part 51 and a liner contact part 52.

The liner insert part 51 is inserted into the support 40. For example, the liner insert part 51 is inserted into an insert depression 411 formed in the support insert part 41 so that the liner 50 can be prevented from undesirably moving, thus facilitating replacement and assembly of the liner 50. Here, the insert depression 411 has an angled shape, and the support insert part 41 may have a shape corresponding to the angled shape.

The liner contact part 52 extends from the liner insert part 51, and comes into contact with the rack 30. The space for storing lubricant is formed in the liner contact part 52. For example, the liner contact part 52 may have a contact surface having a predetermined curvature so that the liner contact part 52 can come into contact with the rack 30.

The liner contact part 52 may have a plurality of recesses 521 which are formed to store the lubricant. In detail, when it is assumed that a contact surface of the liner contact part 52 that comes into contact with the rack 30 is a front surface (a left surface of the liner contact part 52 in FIG. 4), the plurality of recesses 521 may be formed in the front surface of the liner contact part 52 at positions spaced apart from each other. Hence, portions of the front surface of the liner contact part 52 other than the recesses 521 come into contact with the rack 30, thus reducing a contact surface area between the liner contact part 52 and the rack 30.

In the case where the material of the liner 50 includes metal, the recesses 521 may be formed in the front surface of the liner contact part 52 through a pressing process. The lubricant may be stored in the recesses 521. The lubricant that is stored in the recesses 521 may flow out therefrom and be supplied to the front surface of the liner contact part 52. Furthermore, in the case where portions of a rear surface of the liner contact part 52 protrude by the pressing process, insert depressions may be formed in the support insert part 41 so that the protruding portions can be inserted into the respective insert depressions, thus preventing the liner 50 from undesirably moving.

The liner 50 in accordance with an embodiment of the present disclosure may further include a liner coating layer 53. The surface of the liner contact part 52 may be coated with the liner coating layer 53 so that the durability of the liner contact part 52 can be enhanced. In detail, the liner coating layer 53 may be formed by a diamond-like carbon (DLC) coating method. DLC is an amorphous carbon-based new material which is a thin film-shaped material prepared by electrically accelerating carbon ions in plasma or activated hydrocarbon molecules and smashing them on a substrate. DLC is similar to diamond in physical properties such as high hardness, corrosion resistance, and abrasion resistance.

The operation of the rack and pinion steering apparatus in accordance with an embodiment of the present disclosure having the above-mentioned configuration will be described below.

In a state in which the pinion 20 is inserted into the housing 10 and the rack 30 passes through the housing 10 and engages with the pinion 20, the liner 50 is inserted into the housing 10 through the mounting hole 12 formed in the housing 10, and the support 40 is coupled to the housing 10.

Here, the support 40 includes the support insert part 41 which comes into contact with the liner 50 to support the liner 50, the support fixing part 42 which is mounted to the housing 10, and the elastic support part 43 which is disposed between the support insert part 41 and the support fixing part 42 and has elasticity so as to elastically support the support insert part 41.

The liner 50 has the liner coating layer 53 on the surface thereof so that the abrasion resistance thereof can be enhanced. The recesses 521 that can store lubricant are formed in the liner 50 so as to reduce the contact surface area with the rack 30 and increase the residual time of the lubricant.

In the rack and pinion steering apparatus 1 in accordance with an embodiment of the present disclosure, the lubricant can be stored in the liner 50 that comes into contact with the rack 30, so that the use time of the lubricant can be increased.

In the rack and pinion steering apparatus 1 in accordance with an embodiment of the present disclosure, the recesses 521 that can store the lubricant is formed in the liner contact part 52, whereby the contact surface area between the liner 50 and the rack 30 can be reduced, and abrasion between the liner 50 and the rack 30 can be restrained.

In the rack and pinion steering apparatus 1 in accordance with an embodiment of the present disclosure, the liner contact part 52 is coated with the liner coating layer 53, so that the durability and the abrasion resistance of the liner contact part 52 can be enhanced, whereby the lifetime of the liner 50 can be increased.

While the present disclosure has been described with reference to the specific embodiments illustrated in the attached drawings, this is only for illustrative purposes, and it will be apparent to those skilled in the art that various modifications and other equivalent embodiments may be made without departing from the spirit and scope of the present disclosure as defined in the following claims. Therefore, the spirit and scope of the present disclosure should be defined by the accompanying claims.

What is claimed is:

1. A rack and pinion steering apparatus comprising:
a housing;
a pinion inserted into the housing and configured to be rotatable;
a rack configured to pass through the housing and engage with the pinion so that the rack moves linearly;
a support mounted to the housing; and
a liner supported by the support, coming into contact with the rack, and configured to store a lubricant therein.

2. The rack and pinion steering apparatus according to claim 1, wherein the support comprises:
a support insert part inserted into a mounting hole formed in the housing, and configured to support the liner; and
a support fixing part coupled to the housing and covering the mounting hole.

3. The rack and pinion steering apparatus according to claim 2, wherein the support further comprises an elastic support part disposed between the support insert part and the support fixing part and elastically supporting the support insert part.

4. The rack and pinion steering apparatus according to claim 2, wherein the support insert part has a shape corresponding to a shape of the liner and comes into surface contact with the liner.

5. The rack and pinion steering apparatus according to claim 1, wherein the liner comprises:
a liner insert part inserted into the support; and
a liner contact part extending from the liner insert part, coming into contact with the rack, and having space that stores the lubricant.

6. The rack and pinion steering apparatus according to claim 5, wherein the liner insert part is inserted into an insert depression formed in the support so that the liner is prevented from moving.

7. The rack and pinion steering apparatus according to claim 5, wherein a plurality of recesses are formed in the liner contact part, the plurality of recesses being configured to store lubricant.

8. The rack and pinion steering apparatus according to claim 7, wherein the recesses are formed in the liner contact part of the liner through a pressing process.

9. The rack and pinion steering apparatus according to claim 5, wherein the liner further comprises a liner coating layer applied to the liner contact part and configured to increase durability of the liner.

10. The rack and pinion steering apparatus according to claim 9, wherein the liner coating layer is formed by a diamond-like carbon (DLC) coating method.
